(19) United States
(12) Patent Application Publication
(10) Pub. No.: US 2019/0222170 A1
(43) Pub. Date: Jul. 18, 2019

(54) PHOTOVOLTAIC POWER GENERATION DEVICE

(71) Applicant: Panasonic Intellectual Property Management Co., Ltd., Osaka (JP)

(72) Inventors: Koichi Kubo, Osaka-fu (JP); Naofumi Hayashi, Osaka-fu (JP); Minoru Higuchi, Osaka-fu (JP)

(73) Assignee: Panasonic Intellectual Property Management Co., Lt d., Osaka (JP)

(21) Appl. No.: 16/360,705

(22) Filed: Mar. 21, 2019

Related U.S. Application Data
(63) Continuation of application No. PCT/JP2017/032264, filed on Sep. 7, 2017.

(30) Foreign Application Priority Data
Sep. 30, 2016 (JP) 2016-194651

(51) Int. Cl. H02S 30/10; H02S 20/23; F16B 5/06

(52) U.S. Cl. CPC H02S 30/10; F16B 5/065; H02S 20/23

(57) ABSTRACT

This photovoltaic power generation device is provided with: a mounting bracket which is fixed to a roof and on which a frame, arranged on the ridge-side end of a solar cell module, and a frame, arranged on the eave-side end of a solar cell module, are mounted; and a securing bracket for securing the frames to the mounting bracket. The ridge-side edge of the mounting bracket is inclined in the eaves-ridge direction and the girder direction of the roof.

### CROSS-REFERENCE TO RELATED APPLICATION

The present application is a continuation under 35 U.S.C. § 120 of PCT/JP2017/032264, filed Sep. 7, 2017, which is incorporated herein by reference and which claimed priority to Japanese Patent Application No. 2016-194651 filed Sep. 30, 2016. The present application likewise claims priority under 35 U.S.C. § 119 to Japanese Patent Application No. 2016-194651 filed Sep. 30, 2016, the entire content of which is also incorporated herein by reference.

### TECHNICAL FIELD

The present disclosure relates to a photovoltaic power generation device.

### BACKGROUND

A photovoltaic power generation device is built by attaching a plurality of solar cell modules to a roof. For example, Japanese Unexamined Patent Application Publication No. 2015-214877 discloses a photovoltaic power generation device including an anchorage including an eave-side engagement hook that engages with an eave-side solar cell module, and a ridge-side engagement hook that engages with a ridge-side solar cell module. Such an anchorage is fixed to the roof using screws.

### SUMMARY

In installing a photovoltaic power generation device on a roof ensuring good drainage and waterproof capability of the roof is an important issue. Building a conventional photovoltaic power generation device is troublesome because, for example, the peripheries of brackets attached to roofing materials need to be sealed to prevent entry of rain water, etc., from the peripheries of the brackets.

A photovoltaic power generation device according to an aspect of the present disclosure includes: a first solar cell module including a first solar cell panel and a first frame installed at end portions of the panel; a second solar cell module including a second solar cell panel and a second frame installed at end portions of the panel, the second solar cell module being disposed next to a ridge-side of the first solar cell module with a space therebetween; a mounting bracket to be fixed to a roof, the mounting bracket allowing a part of the first frame, the part being installed at a ridge-side end portion of the first solar cell module, and a part of the second frame, the part being installed at an eave-side end portion of the second solar cell module, to be mounted thereon; and a fixing bracket for fixing the first and second frames to the mounting bracket, with a ridge-side edge portion of the mounting bracket being inclined relative to an eave-ridge direction and a girder direction of the roof.

According to the photovoltaic power generation device according to an aspect of the present disclosure, it is possible to sufficiently ensure good drainage and waterproof capability of a roof while building is easy.

### BRIEF DESCRIPTION OF DRAWINGS

The figures depict one or more implementations in accordance with the present teachings, by way of example only, not by way of limitations. In the figures, like reference numerals refer to the same or similar elements.

FIG. 1 is an exploded perspective view of a photovoltaic power generation device according to an example embodiment.

FIG. 2 is a sectional view of a solar cell module according to an example embodiment.

FIG. 3 is a plan view of a mounting bracket according to an example embodiment.

FIG. 4 is a sectional view along line AA in FIG. 3.

FIG. 5 is a perspective view of a base bracket according to an example embodiment.

FIG. 6 is a lateral cross-sectional view illustrating a state in which a base bracket is attached to a mounting bracket.

FIG. 7 is a perspective view of a fixing bracket according to an example embodiment.

FIG. 8A is a longitudinal cross-sectional view illustrating a structure of attachment of a photovoltaic power generation device according to an example embodiment.

FIG. 8B is an enlarged view of a part of FIG. 8A.

FIG. 9 is a plan view of a mounting bracket according to another example embodiment.

FIG. 10 is a sectional view along line BB in FIG. 9.

FIG. 11 is a plan view of a mounting bracket according to another example embodiment.

FIG. 12 is a sectional view along line CC in FIG. 11.

FIG. 13 is a perspective view of a fixing bracket according to another example embodiment.

FIG. 14 is a longitudinal cross-sectional view illustrating a structure for attachment of a photovoltaic power generation device according to another example embodiment.

### DESCRIPTION OF EMBODIMENTS

In a photovoltaic power generation device according to an aspect of the present disclosure, a ridge-side edge portion of a mounting bracket fixed to a roof is inclined relative to an eave-ridge direction and a girder direction of the roof and thus rain water, etc., is not blocked by the mounting bracket but flows to the eave side along the inclined ridge-side edge portion of the bracket. Therefore, even if sealing of the periphery of the mounting bracket is omitted or simplified, good drainage and waterproof capability of the roof can sufficiently be ensured. In other words, according to the photovoltaic power generation device of the present disclosure, it is possible to provide both favorable building efficiency and excellent drainage and waterproof capability.

An example embodiment will be described in detail below with reference to the drawings. The drawings referred to in the embodiments are schematic drawings, and thus dimensions, etc., of components drawn in the drawings should be determined in consideration of the below description. In the present description, taking “substantially the same” as an example, the term “substantially” is intended to indicate not only “completely the same” but also “being able to be considered as substantially the same”. The embodiments described below are mere examples and the photovoltaic power generation device according to the present disclosure is not limited to such embodiments.

In the following, a direction of a mounting bracket, etc., along an eave-ridge direction of a roof is the “longitudinal direction”, and a direction of a mounting bracket, etc., along a girder direction (direction perpendicular to the eave-ridge direction) of the roof is the “lateral (right-left) direction”. A direction of a mounting bracket, etc., along a direction perpendicular to a roof surface on which the mounting bracket is mounted (where the mounting bracket is mounted on roofing materials, surfaces of the roofing materials) is the “top-bottom direction”. In the drawings, the eave-ridge direction of the roof and the longitudinal direction are indicated by arrow a, the girder direction and the lateral direction are indicated by arrow β and the top-bottom direction is indicated by arrow y. Unless specifically stated otherwise, an upper end of, for example, a mounting bracket means an upper end in the top-bottom direction.

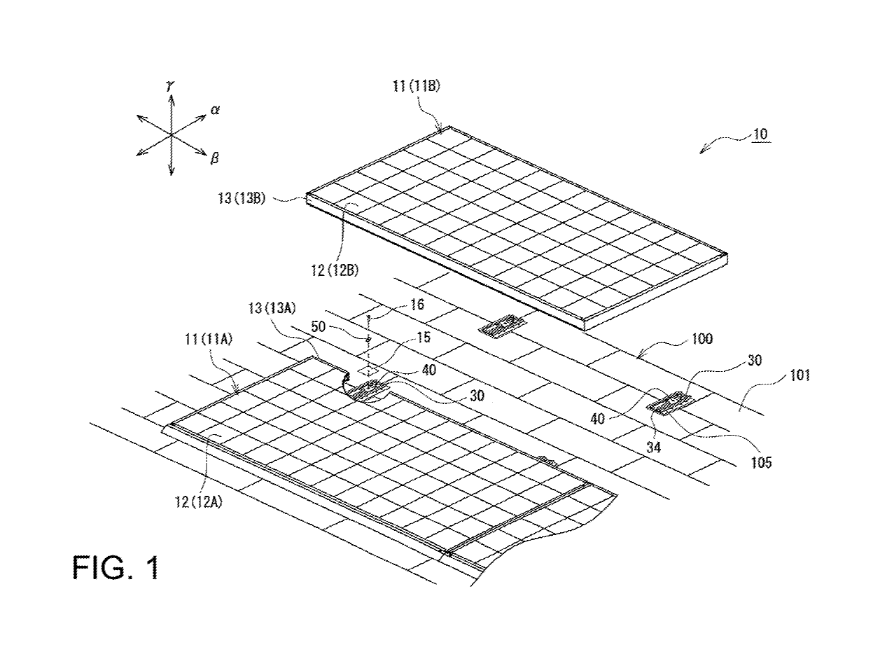

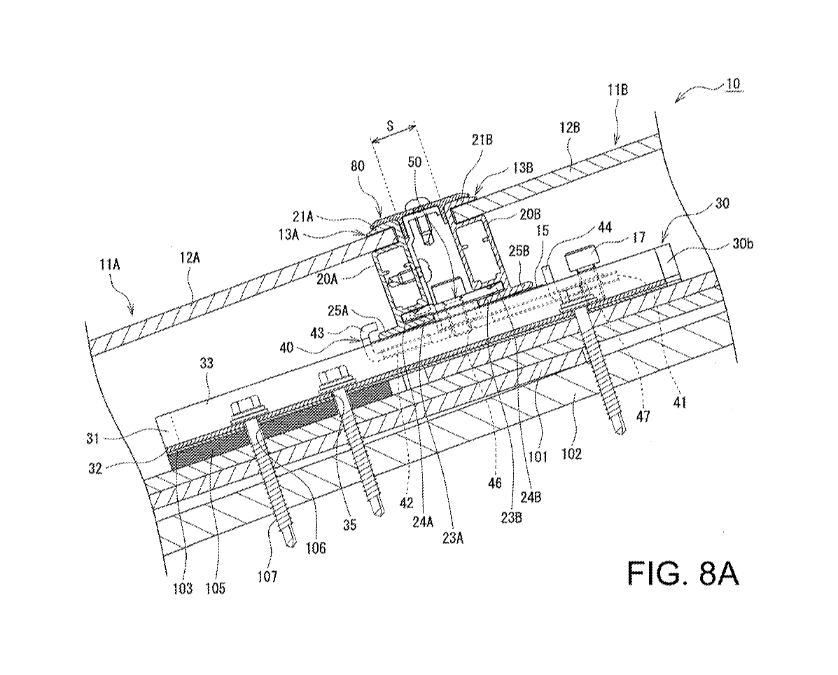

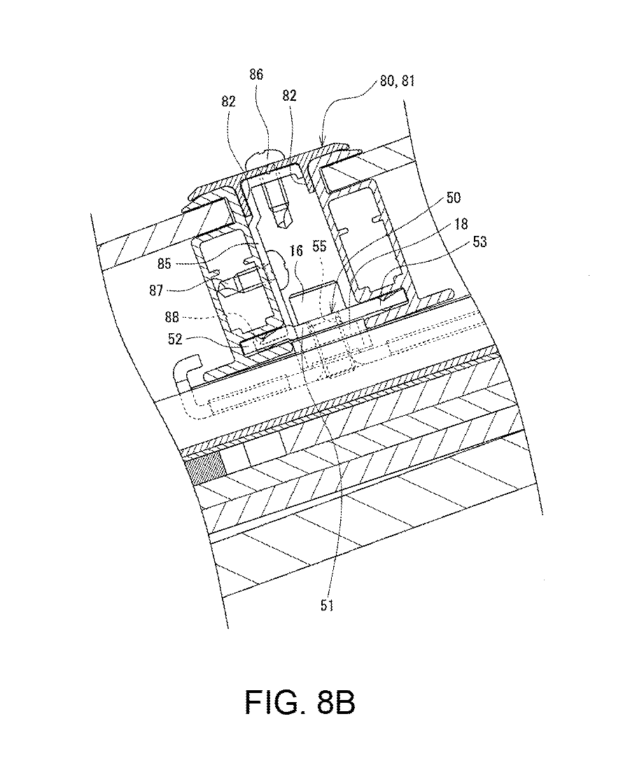

FIG. 1 is an exploded perspective view of a photovoltaic power generation device 10 according to an example embodiment. As illustrated FIG. 1, the photovoltaic power generation device 10 includes a solar cell module 11A (first solar cell module), a solar cell module 11B (second solar cell module), mounting brackets 30 and fixing brackets 50. The solar cell module 11A includes a solar cell panel 12A (first solar cell panel) and a frame 13A (first frame) installed at end portions of the panel. The solar cell module 11B includes a solar cell panel 12B (second solar cell panel) and a frame 13B (second frame) installed at end portions of the panel. The solar cell module 11B is disposed next to the ridge-side of the solar cell module 11A with a space S (see FIG. 8A) between the solar cell module 11A and the solar cell module 11B.

The photovoltaic power generation device 10 is built by attaching the plurality of solar cell modules 11 (11A, 11B) to a roof 100. In the present description, for convenience of description, of the two solar cell modules 11 disposed next to each other in the eave-ridge direction, a module disposed on the eave side is the solar cell module 11A and a module disposed on the ridge-side is the solar cell module 11B. In the present embodiment, the solar cell modules 11 all have the same shape.

Although described in detail later, the mounting brackets 30 are brackets that are fixed to the roof 100 and allow a part of the frame 13A installed at a ridge-side end portion of the solar cell module 11A and a part of the frame 13B installed at an eave-side end portion of the solar cell module 11B to be mounted thereon. The fixing brackets 50 are brackets for fixing the frames 13A, 13B to the mounting brackets 30. Respective ridge-side edge portions of the mounting brackets 30 are inclined relative to the eave-ridge direction and the girder direction of the roof 100.

In the present embodiment, an earthing bracket 15 is provided on each mounting bracket 30, and the frames 13A, 13B are installed on the mounting brackets 30 via the earthing brackets 15. Preferably, the photovoltaic power generation device 10 includes base brackets 40 that each allow a bolt 16 to be fastened thereto and the mounting brackets 30 each include a guide rail portion 34 that supports a base bracket 40 in such a manner that the base bracket 40 is slidable in the eave-ridge direction. Then, the fixing brackets 50 are fixed to the respective mounting brackets 30 via the respective base brackets 40 inserted into the guide rail portions 34.

The photovoltaic power generation device 10 is attached to the roof 100 formed by laying roofing materials 101. The roofing materials 101 are, for example, slate tiles. The roofing materials 101 are disposed in the eave-ridge direction with ridge-side roofing materials 101 overlapping respective parts of eave-side roofing materials 101, and thus, steps are formed at the parts where the roofing materials 101 overlap each other. Here, the roof to which the photovoltaic power generation device 10 is attachable is not limited to the roof 100.

The photovoltaic power generation device 10 is built by fixing the solar cell modules 11 to the plurality of mounting brackets 30 disposed on the roofing materials 101. The mounting brackets 30 are, for example, mounted on the roofing materials 101 and spacers 105, and are fastened to a sheathing roof board 102 (see FIG. 8 referred to later) of the roof 100 via screws. The spacers 105 are provided at the step parts formed between the respective roofing materials 101 and fill the steps to enable stable attachment of the mounting brackets 30. As a result of the mounting brackets 30 being disposed directly on the roofing materials 101 and the spacer 105, heights of the solar cell modules 11 from the roof surface (surfaces of the roofing materials 101) can be reduced, enhancing the integrity of the roof 100 and the photovoltaic power generation device 10.

As described above, each solar cell module 11 includes a solar cell panel 12 and a frame 13. The solar cell panel 12 is, for example, a substantially flat panel in which a plurality of solar cells are held between two protection members. The frame 13 is, for example, formed by means of extrusion molding of a metal material containing aluminum as a main component and is disposed so as to surround the four sides of the solar cell panel 12. A coating film is generally formed on surfaces of the frame 13.

Each solar cell module 11 is fixed to the mounting brackets 30 via the base brackets 40, the fixing brackets 50 and the bolts 16, using the relevant frame 13. In the example illustrated in FIG. 1, a plurality of solar cell modules 11 are disposed in such a manner that a short side direction of each solar cell module 11 having a substantially rectangular shape in plan view is substantially parallel to the eave-ridge direction. Solar cell modules 11 that are next to each other in the girder direction are disposed substantially in contact with each other, and solar cell modules 11 that are next to each other in the eave-ridge direction (solar cell modules 11A, 11B) are disposed with a space S therebetween.

Each solar cell module 11 is preferably fixed to mounting brackets 30 at a total of four parts that are two parts of an eave-side end portion and two parts of a ridge-side end portion thereof. The mounting brackets 30 are disposed on the rear side of one solar cell module 11 at, for example, respective positions corresponding to the right and the left of an eave-side end portion of the module and respective positions corresponding to the right and the left of a ridge-side end portion of the module. The frames 13A, 13B of the two solar cell modules are mounted on mounting brackets 30 disposed at a boundary portion between the solar cell modules 11A, 11B.

An eave-side end portion and a ridge-side end portion of the photovoltaic power generation device 10 may be fixed to the roof 100 using mounting brackets 30, base brackets 40 and fixing brackets 50 or may be fixed to the roof 100 using dedicated brackets.

In the example illustrated in FIG. 1, a plurality of mounting brackets 30 are aligned in the eave-ridge direction and the girder direction. The mounting brackets 30 aligned in the eave-ridge direction are arranged at a certain interval in the eave-ridge direction according to a length along the eave-ridge direction of each solar cell module 11. Each mounting bracket 30 is fixed to the roof 100 in such a manner that the guide rail portion 34 extends along the eave-ridge direction. The frames 13A, 13B are mounted on the mounting brackets 30 so as to be substantially orthogonal to the guide rail portions 34.

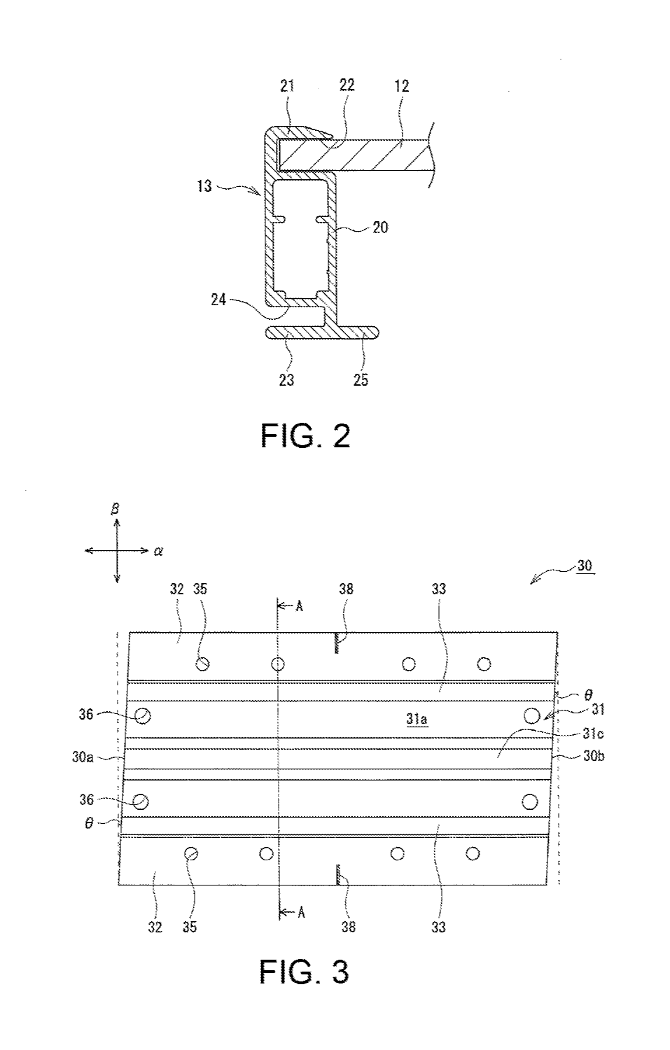

FIG. 2 is a sectional view of an end portion of a solar cell module 11. As illustrated in FIG. 2, a frame 13 installed at an end portion of each solar cell panel 12 includes a body portion 20 having a hollow prism shape, an inner groove 22 that opens toward the inside of the relevant module, and an outer groove 24 that opens toward the outside of the module. Also, the frame 13 includes an inner flange portion 25 that juts toward the inside of the module. The body portion 20, the outer groove 24 and the inner flange portion 25 are positioned on the rear side of the solar cell panel 12, and specifically, the outer groove 24 and the inner flange portion 25 are used for fixing of the solar cell module 11 to mounting brackets 30.

The frame 13 includes a hook portion 21 provided upright on an upper surface of the body portion 20, and an inner groove 22, which is a space that allows the solar cell panel 12 to be inserted thereto, is formed between the upper surface of the body portion 20 and the hook portion 21. The hook portion 21 extends straight upward from the outer side of the body portion 20 and is flexed inward partway, forming a substantially L-shape in cross section. In other words, the hook portion 21 covers a side surface along the top-bottom direction of the solar cell panel 12 and juts onto a light receiving surface of the solar cell panel 12. A length of a part of the hook portion 21, the part jutting onto the light receiving surface, is, for example, substantially equal to a width of the body portion 20. In the frame 13, a bottom plate 23 extending to the side (outer side) opposite to the inner flange portion 25 is provided and an outer groove 24 is formed between a lower surface of the body portion 20 and the bottom plate 23. The bottom plate 23 forms a bottom surface of the frame 13 jointly with the inner flange portion 25.

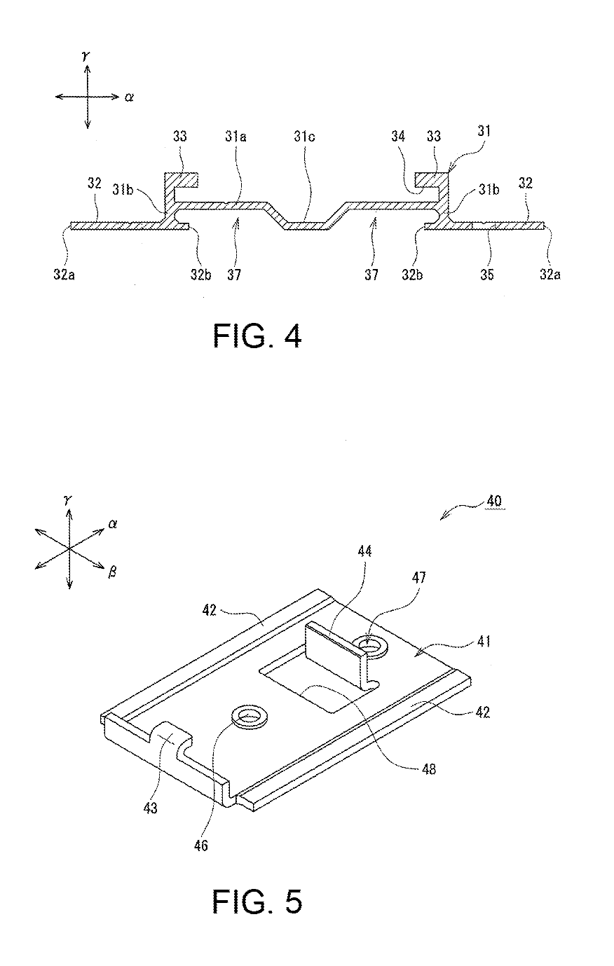

FIG. 3 is a plan view of a mounting bracket 30 and FIG. 4 is a sectional view along line AA in FIG. 3. As illustrated in FIGS. 3 and 4, each mounting bracket 30 includes a base portion 31 that allows a base bracket 40 to be mounted thereon and flange portions 32 that jut to the right and the left, respectively, from a lower portion of the base portion 31. Each mounting bracket 30 includes plate-like fixing portions to be disposed along the roof surface, in which through holes allowing screws for fixing the relevant bracket to the roof 100 to be passed therethrough are formed. The through holes are preferably formed at respective positions no less than 10 mm away from relevant ends of the fixing portions. In the present embodiment, flange portions 32 are provided as the fixing portions.

Each mounting bracket 30 has a shape that is longitudinally long along the eave-ridge direction. A ridge-side edge portion 30b of each mounting bracket 30 is inclined relative to the eave-ridge direction and the girder direction of the roof 100. Since the guide rail portion 34 preferably extends straight along the eave-ridge direction, the ridge-side edge portion 30b is preferably inclined by forming a cut surface of the ridge-side edge portion 30b obliquely relative to the longitudinal direction and the lateral direction. In this case, drainage for rain water, etc., can be enhanced without impairing building efficiency. In other words, rain water, etc., is blocked by the mounting bracket 30 and flows to the eave side along the ridge-side edge portion 30b. Thus, rain water, etc., does not accumulate around the mounting bracket 30 and is less likely to enter from the periphery of the bracket.

An eave-side edge portion 30a of the mounting bracket 30 is preferably inclined at an angle that is substantially the same as that of the ridge-side edge portion 30b relative to the eave-ridge direction and the girder direction of the roof 100. In other words, the eave-side edge portion 30a is preferably formed substantially parallel to the ridge-side edge portion 30b. The inclination of the eave-side edge portion 30a has no influence on the drainage. However, generally, mounting brackets 30 are manufactured by cutting an elongated member, and thus cutting respective end portions at the same angle in the same direction makes it possible to eliminate waste of materials. Here, a mark such as a V-groove or a punch mark used for marking of the eave-ridge direction may be formed in the mounting bracket 30. The mark is formed at, for example, a center of a part, in the vicinity of the eave-side edge portion 30a, of an upper surface of an upper wall portion 31a.

The ridge-side edge portion 30b of the mounting bracket 30 is preferably inclined at an angle θ of approximately 3° to 15° relative to the girder direction of the roof 100. If the angle θ falls within such a range, both favorable building efficiency and drainage can easily be achieved. The eave-side edge portion 30a is also preferably inclined at an angle θ of approximately 3° to 15° relative to the girder direction. The mounting bracket 30 has, for example, a substantial parallelogram shape in plan view in which the eave-side edge portion 30a and the ridge-side edge portion 30b are substantially parallel to each other and outer ends 32a of the respective flange portions 32 are substantially parallel to each other.

The base portion 31 includes the upper wall portion 31a that allows the base bracket 40 to be mounted thereon and side wall portions 31b extending downward from opposite end portions in the lateral direction of the upper wall portion 31a, the side wall portions 31b connecting the upper wall portion 31a and the flange portions 32. In the base portion 31, for example, the respective side wall portions 31b are formed substantially perpendicularly to the upper wall portion 31a. At a center portion in the lateral direction of the upper wall portion 31a, a recess portion 31c that sags downward is formed over an entire longitudinal length thereof. The provision of the recess portion 31c makes it possible to prevent a shaft portion of a bolt 16 fixed to the base bracket 40 from interfering with the upper wall portion 31a.

Hook portions 33 are formed on the base portion 31. In the mounting bracket 30, a pair of hook portions 33 are provided upright at respective opposite end portions in the lateral direction of the position upper wall portion 31a. The hook portions 33 extend straight upward from the opposite end portions in the lateral direction of the upper wall portion 31a and are flexed inward partway, forming a substantially L-shape in cross section. The upper wall portion 31a and the hook portions 33 form a guide rail portion 34 that supports the base bracket 40 in such a manner that the base bracket 40 is slidable in the longitudinal direction.

Parts, other than the recess portion 31c, of the upper wall portion 31a of the base portion 31 are formed at positions that are higher than the flange portions 32 that are in contact with the roof surface. Therefore, below the upper wall portion 3a, a space is provided between the upper wall portion 31a and the roof surface. The mounting bracket 30 preferably includes drainage channels 37 formed over an entire longitudinal length thereof along the eave-ridge direction by providing spaces between the mounting bracket 30 and the roof surface. In the mounting bracket 30, drainage channels 37 are formed on the right and the left of the recess portion 31c. The provision of the drainage channels 37 further enhances the drainage of the roof 100 at a site at which the photovoltaic power generation device 10 is installed.

The flange portions 32, which jut outward from the lower portion of the base portion 31, are formed over the entire longitudinal length of the mounting bracket 30. The flange portions 32 preferably also extend to the inside of the base portion 31, that is, below the upper wall portion 31a. A lateral length of the parts extending to the inside of the base portion 31 may be shorter than a lateral length of the hook portions 33. The side wall portions 31b of the base portion 31 are formed, for example, substantially perpendicular to the flange portions 32. In each flange portion 32, a plurality of through holes 35 that each allow a screw 107 (see FIG. 8A referred to later) to be passed therethrough are formed so as to be aligned in the eave-ridge direction.

As described above, the through holes 35 are preferably formed at the respective positions no less than 10 mm away from the relevant ends of the flange portions 32. As a result of the through holes 35 being formed away from the ends of the flange portions 32, rain water, etc., is less likely to enter the parts to which the screws 107 are attached. The through holes 35 are formed, for example, at positions no less than 10 mm away from outer ends 32a, these ends being on the outer sides along the longitudinal direction of the flange portions 32, and opposite end portions in the longitudinal direction of the flange portions 32 (the eave-side edge portion 30a and the ridge-side edge portion 30b). Also, the through holes 35 are preferably formed at respective positions that are also no less than 10 mm away from inner ends 32b, which are inner ends along the longitudinal direction of the flange portions 32 and are in contact with the respective drainage channels 37. The through holes 35 are formed, for example, at respective positions substantially the same distance away from the relevant outer ends 32a and the relevant inner ends 32b.

In each mounting bracket 30, binding band holes 36 that allow binding bands (not illustrated) for fixing wires drawn out from the respective solar cell modules 11 to be passed therethrough may be formed. In the example illustrated in FIG. 3, a total of four binding band holes 36, two binding band holes 36 in each of opposite end portions in the longitudinal direction of the upper wall portion 31a, are formed. For example, each of wires extending in the girder direction of the roof 100 is fixed to an eave-side end portion or a ridge-side end portion of a mounting bracket 30, using binding bands passed through relevant binding band holes 36.

In each mounting bracket 30, alignment marks 38 used at the time of building may be provided. In the example illustrated in FIG. 3, linear alignment marks 38 extending laterally from the respective outer ends 32a are formed in upper surfaces of the respective flange portions 32. The respective alignment marks 38 formed in the right and left flange portions 32 are formed on the same straight line so as to be aligned laterally. Each mounting bracket 30 is disposed on the roof 100, for example, in such a manner that the alignment marks 38 are each aligned with an eave-side edge portion of a roofing material 101.

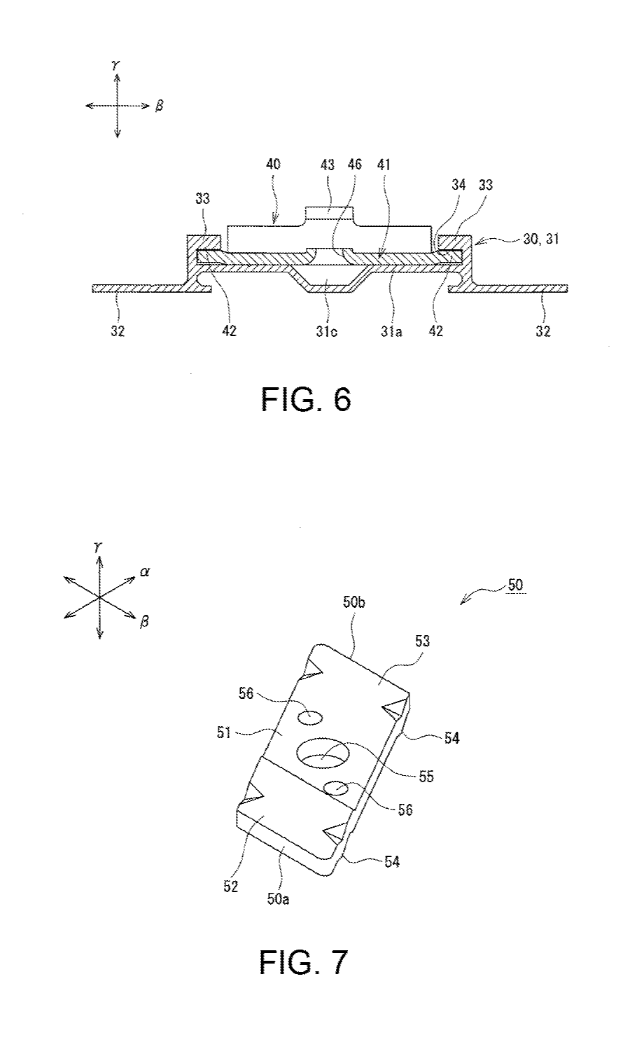

FIG. 5 is a perspective view of a base bracket 40 and FIG. 6 is a lateral cross-sectional view illustrating a state in which a base bracket 40 is attached to a mounting bracket 30. As illustrated in FIGS. 5 and 6, each base bracket 40 includes a base portion 41 that allows a bolt 16 for fixing a fixing bracket 50 to be fastened thereto, and allows extension portions 42 to be inserted into the guide rail portion 34 of the mounting bracket 30. The base portion 41 is formed so as to have a width that enables the base portion 41 to be disposed between respective hook portions 33 of a mounting bracket 30, and to be long longitudinally along the eave-ridge direction.

The extension portions 42 jut from the right and the left of the base portion 41. Upon insertion of the extension portions 42 in the guide rail portion 34, the base bracket 40 engages with the mounting bracket 30, preventing the base bracket 40 from coming off upward. The extension portions 42 are slightly flexed upward at respective roots thereof and an upper surface of each extension portion 42 is thus positioned slightly higher than an upper surface of the base portion 41. The upper surfaces of the extension portions 42 are substantially flat and, for example, upon a bolt 16 being fastened to the base portion 41, come into contact with lower surfaces of hook portions 33 included in the guide rail portion 34, whereby the base bracket 40 is firmly fixed to the mounting bracket 30. However, until the bolt 16 is fastened, the base bracket 40 is slidable along the guide rail portion 34.

Each base bracket 40 may include an engagement portion 43 and a ridge-side standing wall portion 44. As described above, the frames 13A, 13B include inner flange portions 25A, 25B that jut to the insides of the solar cell modules 11A, 11B on the rear sides of the solar cell modules 11A. 11B, respectively. As illustrated in FIG. 8 referred to later, the engagement portion 43 projects upward relative to an upper end of the mounting bracket 30 and engages with the inner flange portion 25A (first inner flange portion) of the frame 13A. The ridge-side standing wall portion 44 projects upward relative to the upper end of the mounting bracket 30 and is disposed so as to face a distal end of the inner flange portion 25B (second inner flange portion) of the frame 13B.

The engagement portion 43 is formed in a substantially L-shape in cross section, with a space that enables insertion of the inner flange portion 25A thereto between the engagement portion 43 and the base portion 41 at an eave-side end portion (one longitudinal end portion) of the base portion 41. The ridge-side standing wall portion 44 is formed at a position at which the ridge-side standing wall portion 44 faces the distal end of the inner flange portion 25B, with a height that does not hinder installment of the frame 13B. Since the ridge-side standing wall portion 44 is formed by, for example, flexing a part of a metal plate forming the base portion 41 between a ridge-side end portion (another longitudinal end portion) of the base portion 41 and a longitudinal center portion of the base portion 41, in order to enable such flexing, an opening portion 48 is formed on the eave side of the ridge-side standing wall portion 44.

A bolt fastening portion 46 that allows a bolt 16 to be threadably connected thereto, and a temporary fixing bolt fastening portion 47 that allows a temporary fixing bolt 17 (see FIG. 8A referred to later) to be threadably connected thereto, are preferably formed in each base bracket 40. The bolt fastening portion 46 is formed in a part between the engagement portion 43 and the ridge-side standing wall portion 44 of the base portion 41, the part overlapping the recess portion 31c of a mounting bracket 30 in the top-bottom direction. The temporary fixing bolt fastening portion 47 is formed in a part on the ridge-side relative to the ridge-side standing wall portion 44 of the base portion 41. Each of the bolt fastening portions is formed by, for example, subjecting the metal plate forming the base portion 41 to burring and threading.

FIG. 7 is a perspective view of a fixing bracket 50. As illustrated in FIG. 7, each fixing bracket 50 includes a base portion 51 including a through hole 55 formed therein, the through hole 55 allowing a bolt 16 to be passed therethrough, a first engagement portion 52 extending to the eave side from the base portion 51, and a second engagement portion 53 extending to the ridge-side from the base portion 51. The first engagement portion 52 is a part to be inserted into the outer groove 24A of the frame 13A and the second engagement portion 53 is a part to be inserted into the outer groove 24B of the frame 13B. Each fixing bracket 50 is a bracket in which the first engagement portion 52 and the second engagement portion 53 are joined by the base portion 51, and the engagement portions are thereby integrated.

Each fixing bracket 50 is a bracket having a substantial parallelogram shape in plan view, which is elongated in a direction in which the base portion 51 and the engagement portions are aligned. The shape of each fixing bracket 50 in plan view is not specifically limited but is preferably a parallelogram shape other than a rectangular shape. An eave-side edge portion 50a and a ridge-side edge portion 50b, that is, an eave-side edge portion of the first engagement portion 52 and a ridge-side edge portion of the second engagement portion 53, of each fixing bracket 50 are substantially parallel to each other and form short sides of the parallelogram. Two corner portions that are obtuse angles of the parallelogram are formed so as to each have, for example, an angle of 120°. Two corners that are acute angles of the parallelogram may be chamfered. Here, the shape of each fixing bracket 50 in plan view may be another parallel polygon shape such as a parallel hexagon shape.

If each fixing bracket 50 has a substantial parallelogram shape in plan view, a length (length of the long side) of each fixing bracket 50 is, for example, equal to or larger than a width of the space S but equal to or smaller than a length from an innermost portion of the outer groove 24A of the frame 13A to an innermost portion of the outer groove 24B of the frame 13B. The eave-side edge portion 50a and the ridge-side edge portion 50b, which form the respective short sides of the parallelogram, of each fixing bracket 50 may each have a length that allows the eave-side edge portion 50a and the ridge-side edge portion 50b to abut on the innermost portions of the outer grooves 24A, 24B, respectively. Also, a width (length of the short sides) of each fixing bracket 50 is preferably less than the width of the space S so that the respective engagement portions completely come off from the outer grooves 24A, 24B when the fixing bracket 50 is rotated so that the long sides extend laterally. A thickness of each fixing bracket 50 only needs to be a thickness that allows insertion of the outer grooves 24A, 24B.

Each fixing bracket 50 is slightly flexed upward at a boundary portion between the base portion 51 and the first engagement portion 52 and a lower surface of the first engagement portion 52 is thus located slightly above a lower surface of the base portion 51. As illustrated in FIG. 8 referred to later, because of an inclination of the roof surface, a distal end of a bottom plate 23A of the frame 13A floats slightly from the mounting brackets 30. Therefore, forming a step at the boundary portion between the base portion 51 and the first engagement portion 52 facilitates attachment of the fixing bracket 50 to the frames 13A, 13B.

Each fixing bracket 50 may be slightly curved or flexed in such a manner that the first engagement portion 52 and the second engagement portion 53 are lowered toward respective distal ends (the eave-side edge portion 50a and the ridge-side edge portion 50b). In the example illustrated in FIG. 7, there is no step at a boundary portion between the base portion 51 and the second engagement portion 53, but a step may be provided at the boundary portion.

The base portion 51 is a part to which a bolt 16 is attached, and includes a substantially perfect circle-shaped through hole 55. The through hole 55 is formed, for example, with a point of intersection between the diagonals of the fixing bracket 50 having a substantial parallelogram shape in plan view as a center. Two tool insertion holes 56 may be formed in the base portion 51. The tool insertion holes 56 are holes that are each smaller than the through hole 55 and are formed with the through hole 55 therebetween. The through hole 55 and the respective tool insertion holes 56 are located, for example, on substantially the same straight line. The fixing bracket 50 can be turned within the space S, and for example, at the time of a turning operation, the fixing bracket 50 can be turned around the bolt 16 by inserting a tool having a forked structure (not illustrated) into the tool insertion holes 56.

The first engagement portion 52 extends to the eave side from an eave-side end portion of the base portion 51 and the second engagement portion 53 extends to the ridge-side from a ridge-side end portion of the base portion 51. Each of the engagement portions preferably include projections 54 projecting downward. The projections 54 are formed at opposite end portions in the lateral direction of each engagement portion. Each projection 54 is formed by, for example, pressing a metal plate forming the relevant engagement portion from the upper surface side.

FIGS. 8A and 8B are longitudinal cross-sectional views illustrating a structure for attachment of the photovoltaic power generation device 10, and illustrates a structure in which the ridge-side end portion of the solar cell module 11A and the eave-side end portion of the solar cell module 11B are fixed to the roof 100 using a mounting bracket 30, a base bracket 40, and a fixing bracket 50.

As illustrated in FIGS. 8A and 8B, the frame 13A installed at the ridge-side end portion of the solar cell module 11A and the frame 13B installed at the eave-side end portion of the solar cell module 11B are mounted on a mounting bracket 30 with which a base bracket 40 engages, via an earthing bracket 15. Then, a fixing bracket 50 with the first engagement portion 52 inserted into the outer groove 24A of the frame 13A and the second engagement portion 53 inserted into the outer groove 24B of the frame 13B is fastened to the base bracket 40 via a bolt 16. For the bolt 16, for example, a bolt including a hex key hole in a head portion thereof, the key hole enabling a hex key to be inserted thereto, is used.

The mounting bracket 30 is fixed to the sheathing roof board 102 of the roof 100 by screws 107 attached to the flange portions 32, which are plate-like fixing portions. In the example illustrated in FIG. 8, the mounting bracket 30 is disposed in such a manner that the alignment marks 38 are aligned with an eave-side edge portion of a roofing material 101, and a ridge-side part of the mounting bracket 30 is fixed to the roofing material 101 and an eave-side part of the mounting bracket 30 is fixed to a spacer 105. Some of the screws 107 are passed through the through holes 35 of the flange portion 32 and through holes 106 of the spacer 105 and fixed to the sheathing roof board 102 through roofing materials 101. For each of the screws 107, for example, a packing-provided wood screw is used. A rubber sheet 103 (for example, a butyl rubber sheet) is provided between the mounting bracket 30, and the roofing material 101 and the spacer 105.

The solar cell modules 11A, 11B are fixed to the mounting bracket 30 in such a manner that the solar cell panels 12A, 12B are substantially parallel to the sheathing roof board 102 of the roof 100. Since the roof surface, constituted by surfaces of the roofing materials 101, is not parallel to the sheathing roof board 102, an upper end (upper surfaces of the hook portions 33) of the mounting bracket 30 on which the frames 13A, 13B are mounted is also not parallel to the sheathing roof board 102. Therefore, the distal end of the bottom plate 23A of the frame 13A floats slightly from the mounting brackets 30, and regarding heights of the outer grooves 24A. 24B from the upper ends of the mounting brackets 30, the outer groove 24A is slightly higher. Therefore, the aforementioned step is formed between at the boundary portion between the base portion 51 and the first engagement portion 52 of the fixing bracket 50. Also, regarding heights of the hook portions 21A, 21B, the hook portion 21A is slightly higher.

The base bracket 40 is inserted into the guide rail portion 34 (see FIG. 4, etc.) of the mounting bracket 30. As described above, the guide rail portion 34 is formed over the entire longitudinal length along the eave-ridge direction of the mounting bracket 30. Therefore, until the frames 13A, 13B are mounted on the mounting bracket 30 and fastened via the bolt 16, the base bracket 40 can be slid in the eave-ridge direction within a range in which the base bracket 40 does not stick out from the mounting bracket 30. Although the frames 13A, 13B are mounted on a part of the mounting bracket 30 to which the base bracket 40 is attached, as described above, the base bracket 40 is slidable and thus there is a high degree of flexibility in disposition of the frames 13A, 13B, providing excellent building efficiency.

The base bracket 40 can be temporarily fixed using a temporary fixing bolt 17 so as to prevent the base bracket 40 from moving in the eave-ridge direction when the frames 13A, 13B are disposed. The temporary fixing bolt 17 is threadably connected to the temporary fixing bolt fastening portion 47 formed in the base portion 41 of the base bracket 40 and a distal end of a shaft portion of the temporary fixing bolt 17 is pressed against the upper wall portion 31a of the mounting bracket 30 to temporarily fix the base bracket 40 at an intended position in the mounting bracket 30. The position of the base bracket 40 can easily be adjusted by loosening the temporary fixing bolt 17.

The frame 13A is mounted on the hook portions 33 of the mounting bracket 30 via the earthing bracket 15, and is disposed on the eave side relative to a position corresponding the bolt fastening portion 46 of the relevant base bracket 40. The earthing bracket 15 includes projections projecting upward and a through hole that allows a bolt 16 and a later-described spacer 18 to be passed therethrough. The projection of the earthing bracket 15 sticks out through a coating film formed in a surface of the frame 13A and digs into a bottom surface of the frame 13k enabling earthing. The projection of the earthing bracket 15 also digs into a bottom surface of the frame 13B in a manner that is similar to the above.

The engagement portion 43 of the base bracket 40 is provided upright on the eave side of the frame 13A, and the engagement portion 43 juts out and engages with the inner flange portion 25A of the frame 13A. In other words, the inner flange portion 25A is inserted between the base portion 41 and the engagement portion 43 of the base bracket 40. The inner flange portion 25A is held from above by the engagement portions 43, for example, when negative pressure acts on the solar cell module 11A.

The frame 13B is mounted on the hook portions 33 of the mounting bracket 30 via the earthing bracket 15 and disposed on the ridge-side relative to a position corresponding to the bolt fastening portion 46 of the base bracket 40. In other words, the frame 13B is disposed with a space S between the frame 13B and the frame 13A, the space S allowing the bolt 16 to be passed therethrough. On the ridge-side of the base bracket 40, the ridge-side standing wall portion 44 is provided at a position at which the ridge-side standing wall portion 44 faces the distal end of the inner flange portion 25B, and movement of the solar cell module 11B to the ridge-side is thus prevented.

The fixing bracket 50 is attached straddling the frames 13A, 13B by inserting the first engagement portions 52 and the second engagement portion 53 into the outer groove 24A of the frame 13A and the outer groove 24B of the frame 13B, respectively. The bolt 16 for fixing the fixing bracket 50 is passed through the through hole 55 of the base portion 51 and threadably connected to the bolt fastening portion 46 of the base bracket 40. The bolt 16 fastened to the base bracket 40 presses the base portion 51 from above, whereby the projections 54 (see FIG. 7) of the respective engagement portions inserted in the outer grooves 24A, 24B firmly abut on upper surfaces of the bottom plates 23A, 23B.

The fixing bracket 50 is configured so as to be turnable in a lower part of the space S. After the fixing bracket 50 is bolted to the base bracket 40, for example, to a degree that the fixing bracket 50 is turnable, the fixing bracket 50 turns around a center axis of the bolt 16. More specifically, the first engagement portion 52 can be inserted into the outer groove 24A by turning the fixing bracket 50 using the aforementioned forked structure tool in a state in which the solar cell module 11A is disposed on the eave side of the bolt 16. Then, the solar cell module 11B is disposed on the ridge-side of the bolt 16 and the second engagement portion 53 is inserted into the outer groove 24B, whereby the fixing bracket 50 is attached straddling the frames 13A, 13B. The bolt 16 is fastened to the base bracket 40, for example, after the second engagement portion 53 is inserted into the outer groove 24B.

Here, the frames 13A, 13B can be detached from the fixing bracket 50 by turning the fixing bracket 50 with the respective engagement portions inserted into the outer grooves 24A, 24B around the center axis of the bolt 16 and thereby removing the respective engagement portions from the outer grooves 24A, 24B. More specifically, the respective engagement portions can be removed from the outer grooves 24A. 24B by loosening the bolt 16 and turning the fixing bracket 50 in such a manner that the width direction of the fixing bracket 50 extends along the lateral direction. In other words, in the structure of attachment of the photovoltaic power generation device 10, the respective engagement portions can be inserted/removed into/from the outer grooves 24A, 24B of the frames 13A, 13B by turning the fixing bracket 50 around the bolt 16.

Where the fixing bracket 50 has a substantially parallel polygon shape in plan view, preferably a substantial parallelogram shape, an end surface of the eave-side edge portion (eave-side edge portion 50a) of the first engagement portion 52 inserted into the outer groove 24A may substantially abut along the innermost portion of the outer groove 24A. Also, an end surface of the eave-side edge portion (eave-side edge portion 50a) of the second engagement portion 53 inserted into the outer groove 24B may substantially abut along the innermost portion of the outer groove 24B. As a result of being inserted into the backs of the outer grooves 24A, 24B, the engagement portions can hold the frames 13A, 13B. Where the shape of the fixing bracket 50 is a substantial parallelogram shape other than a rectangular shape, even if the end surfaces of the respective engagement portions are attached so as to abut along the innermost portions of the outer grooves 24A, 24B, the fixing bracket 50 can be turned in such a manner that the width direction (long sides) thereof extends along the lateral direction.

In other words, the fixing bracket 50 is preferably a bracket that turns within the space S, the bracket having a substantially parallel polygon shape in plan view, in which a first end surface of the first engagement portion 52 substantially abuts along the innermost portion of the outer groove 24A and a second end surface of the second engagement portion 53 substantially abuts along the innermost portion of the outer groove 24B. In the present embodiment, the first end surface of the first engagement portion 52 is the end surface of the eave-side edge portion 50a forming one of the short sides of the parallelogram. The second end surface of the second engagement portion 53 is the end surface of the ridge-side edge portion 50b forming the other of the short sides of the parallelogram, the end surface being substantially parallel to the first end surface.

A spacer 18 that supports the base portion 51 of the fixing bracket 50 may be provided between the fixing bracket 50 and the base bracket 40. The spacer 18 is, for example, a tubular body that allows the bolt 16 to be passed therethrough and is disposed on the base bracket 40 in such a manner that a hole of the tube, and the through hole 55 and the bolt fastening portion 46, are aligned with each other. In the example illustrated in FIG. 8, respective distal end portions of the bottom plates 23A, 23B of the frames 13A, 13B abut on an upper end portion of the spacer 18, the upper end portion projecting upward from the upper end of the mounting bracket 30 and being inserted into the space S.

In the structure for attachment of the photovoltaic power generation device 10, as a result of the bolt 16 being threadably connected to the bolt fastening portion 46 of the base bracket 40, the fixing bracket 50 firmly abuts on the bottom plates 23A, 23B of the frames 13A, 13B and the base bracket 40 is firmly fixed to the mounting bracket 30. Upon the bolt 16 being threadably connected to the bolt fastening portion 46, the base bracket 40 is hoisted upward and the extension portions 42 inserted into the guide rail portion 34 firmly abut on the hook portions 33.

The photovoltaic power generation device 10 may include a cover 80 disposed above the space S so as to straddle the frame 13A and the frame 13B, and a support bracket 85 that is inserted in the outer groove 24A of the frame 13A and thereby fixed to the frame 13A and allows the cover 80 to be screw-fastened thereto. The cover 80, for example, has a length that is substantially the same as that of the long sides of the solar cell modules 11 and provides a cover over the space S. The cover 80 includes a base portion 81 that is attached so as to extend from the frame 13A to the frame 13B and covers the space S, and two leg portions 82 that extend downward from the base portion 81 and are inserted into the space S. The respective leg portions 82 are formed so as to be, for example, parallel to each other.

In the cover 80, an eave-side part of the base portion 81 is disposed on the hook portion 21A of the frame 13A, and the ridge-side part of the base portion 81 is disposed on the hook portion 21B of the frame 13B. The eave-side leg portion 82 abuts on a side surface along the top-bottom direction of the frame 13A and the ridge-side leg portion 82 abuts on a side surface along the top-bottom direction of the frame 13B. As described above, regarding the heights of the hook portions 21A, 21B from the upper end of the mounting bracket 30, the hook portion 21A is relatively higher, and thus, for example, the base portion 81 is inclined in such a manner that the eave-side part is located somewhat above the ridge-side part. Also, upper surfaces of distal end portions of the hook portions 21A, 21B are inclined down toward respective distal ends, and thus, a distal end portion of the base portion 81 is slightly flexed downward so as to conform to the shapes of the hook portions.

The support bracket 85 is disposed inside the space S between the frames 13A. 13B and an upper portion of the support bracket 85 abuts on a rear surface of the base portion 81. The cover 80 is fixed to the upper portion of the support bracket 85 using a screw 86 that penetrates a center portion in a width direction of the base portion 81.

The support bracket 85 preferably includes a lug portion 88 to be inserted into the outer groove 24A of the frame 13A. The lug portion 88 is formed, for example, by flexing a lower portion of the support bracket 85 to the side opposite to the upper portion (eave side). The support bracket 85 extends downward along the body portion 20A of the frame 13A and is fixed to the frame 13A by being fixed to the body portion 20A using a screw 87 and the lug portion 88 being inserted into the outer groove 24A. For the screws 86, 87, for example, self-tapping screws are used.

According to the photovoltaic power generation device 10 having the above-described configuration, it is possible to sufficiently ensure drainage and protection capability of the roof while building is easy. Also, it is possible to firmly fix the respective solar cell modules 11 to the roof 100 and provide excellent maintainability.

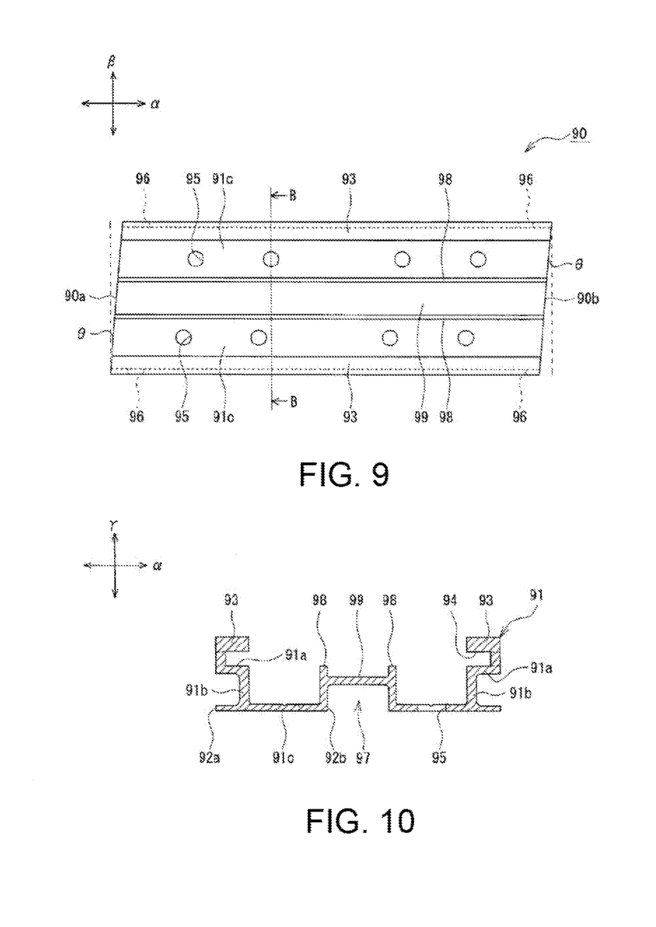

Next, a mounting bracket 90, which is another example embodiment, will be described in detail with reference to FIGS. 9 and 10. The mounting bracket 90 can be used in place of the mounting bracket 30 in the photovoltaic power generation device 10.

FIG. 9 is a plan view of a mounting bracket 90 and FIG. 10 is a sectional view along line BB in FIG. 9. As illustrated in FIGS. 9 and 10, a mounting bracket 90 includes a base portion 91 that allows a base bracket 40 to be mounted thereon. On the other hand, the mounting bracket 90 is different from the mounting bracket 30 in that the mounting bracket 90 has no flange portions jutting to the right and the left of the base portion 91. The mounting bracket 90 is a plate-like fixing portion disposed along a roof surface and includes fixing portions each including through holes that each allow a screw for fixing the bracket to a roof 100 to be passed therethrough. In the mounting bracket 90, lower wall portions 91c of the base portion 91 correspond to the fixing portions.

Like the mounting bracket 30, the mounting bracket 90 has a shape that is long in the longitudinal direction along the eave-ridge direction, and a ridge-side edge portion 90b is inclined relative to the eave-ridge direction and the girder direction of the roof 100. The ridge-side edge portion 90b is preferably inclined at an angle θ of approximately 3° to 10° relative to the girder direction of the roof 100. The ridge-side edge portion 90b is preferably inclined by forming a cut surface of the mounting bracket 90 so as to be inclined relative to the longitudinal direction and the lateral direction. In this case, drainage for rain water, etc., can be enhanced without building efficiency being impaired.

An eave-side edge portion 90a of the mounting bracket 90 is inclined at an angle that is substantially the same as that of the ridge-side edge portion 90b relative to the eave-ridge direction and the girder direction. The eave-side edge portion 90a is formed at an angle that is the same as that of the ridge-side edge portion 90b in a direction that is the same as that of the ridge-side edge portion 90b. Since the mounting bracket 90 is manufactured, for example, by cutting a long member, cutting the respective end portions at the same angle in the same direction enables elimination of waste of materials. The mounting bracket 90 has a substantial parallelogram shape in plan view, in which the eave-side edge portion 90a and the ridge-side edge portion 90b are substantially parallel to each other and outer ends 92a of the lower wall portions 91c are also substantially parallel to each other.

The base portion 91 includes upper wall portions 91a that allow a base bracket 40 to be mounted thereon. The upper wall portions 91a are provided so as to be separated at opposite end portions in the lateral direction of the base portion 91, and a hook portion 93 is formed on each upper wall portion 91a. The hook portion 93 extends straight upward from an outer end portion of the upper wall portion 91a and is flexed inward partway, forming a substantially L-shape in cross section. The upper wall portions 91a and the hook portions 93 form a guide rail portion 94 that supports a base bracket 40 in such a manner that the base bracket 40 is slidable in the longitudinal direction.

The base portion 91 includes side wall portions 91b extending downward from inner end portions of the respective upper wall portions 91a and lower wall portions 91c extending inward from lower end portions of the respective side wall portions 91b. The respective side wall portions 91b are formed substantially perpendicular to the respective upper wall portions 91a and the respective lower wall portions 91c. The lower wall portions 91c are formed substantially parallel to the upper wall portions 91a and can be disposed along the roof surface. The lower wall portions 91c may extend outward from the lower end portions of the side wall portion 91b within a range in which the lower wall portions 91c do not stick out from the outer end portions of the respective upper wall portions 91a.

At a center portion in the lateral direction of the base portion 91, two standing wall portions 98 are formed over an entire longitudinal length thereof. The respective standing wall portions 98 extend upward from inner end portions of the right and left lower wall portions 91c and upper end portions of the standing wall portions 98 are located at a height that is substantially the same as a height of upper surfaces of the upper wall portions 91a. The respective standing wall portions 98 supports a base bracket 40 jointly with the upper wall portions 91a. The base portion 91 is formed substantially perpendicular to the respective standing wall portions 98 and includes a joining portion 99 that joins the respective standing wall portions 98.

The joining portion 99 is preferably formed at a position that is lower than upper ends of the standing wall portion 98 so as to prevent interference of a bolt 16 with the base bracket 40. However, the joining portion 99 is preferably formed so as to have a height that prevents the joining portion 99 from coming in contact with the roof surface. The mounting bracket 90 includes a drainage channel 97 formed by providing a space between the mounting bracket 90 and the roof surface over an entire longitudinal length thereof along the eave-ridge direction. The drainage channel 97 is formed below the joining portion 99 between the respective standing wall portions 98.

In the mounting bracket 90, a plurality of through holes 95 that each allow a screw 107 to be passed therethrough are formed in each lower wall portion 91c of the base portion 91 so as to be aligned in the eave-ridge direction. The through holes 95 are preferably formed at respective positions no less than 10 mm away from outer ends 92a of the lower wall portions 91c and opposite end portions in the longitudinal direction (the eave-side edge portion 90a and the ridge-side edge portion 90b). As a result of the through holes 95 being formed away from the ends of the lower wall portions 91c, which are fixing portions, rain water, etc., is less likely to enter the parts to which the screws 107 are attached. The through holes 95 may be formed at respective positions no less than 10 mm away from inner ends 92b of the lower wall portions 91c that are in contact with the drainage channel 97.

In the mounting bracket 90, binding band holes 96 that allow binding bands for fixing wires drawn out from respective solar cell modules 11 to be passed therethrough may be formed. The binding band holes 96 are formed in root parts of the respective hook portions 93 so as to face sideways. For example, a total of four binding band holes 96, namely two binding band holes 96 in each of opposite end portions in the longitudinal direction of the base portion 91, are formed. Also, in the mounting bracket 90, alignment marks used at the time of building may be provided.

As in the case where the mounting bracket 30 is used, where the mounting bracket 90 has the above-described configuration, favorable building efficiency and maintainability can be provided and drainage and protection capability of the roof 100 can be sufficiently ensured. Since the mounting bracket 90 includes no flange portions largely jutting to the right and the left of the base portion 91, the mounting bracket 90 is narrow compared to the mounting bracket 30 and a width of the mounting bracket 90 is slightly larger than a width of the base bracket 40.

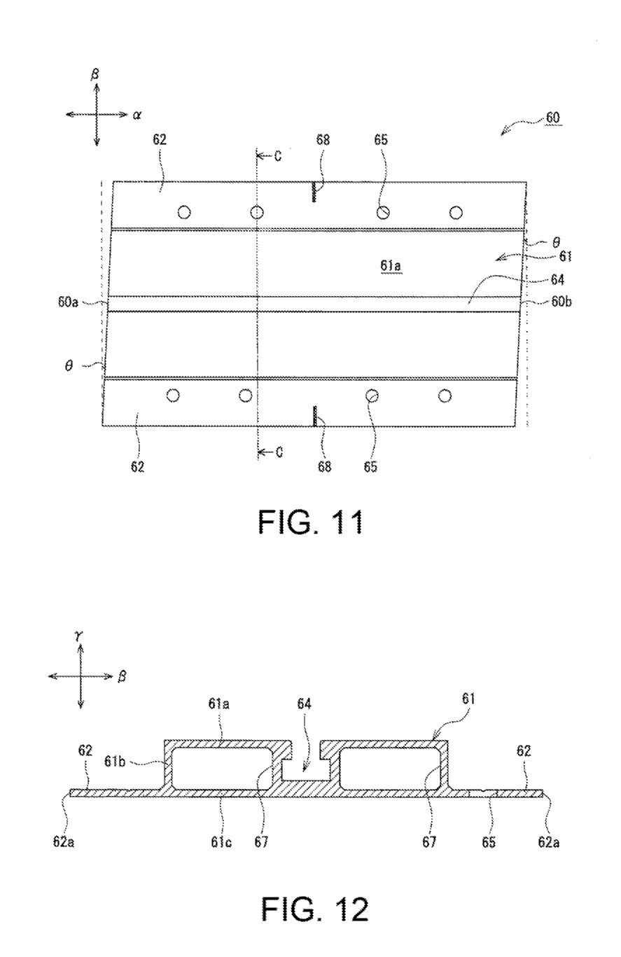

Next, a photovoltaic power generation device 10X, which is another example embodiment, will be described in detail with reference to FIGS. 11 to 14. In the following, for components that are common with the above-described photovoltaic power generation device 10, reference numerals that are the same as those of the photovoltaic power generation device 10 are used and overlapping descriptions thereof will be omitted.

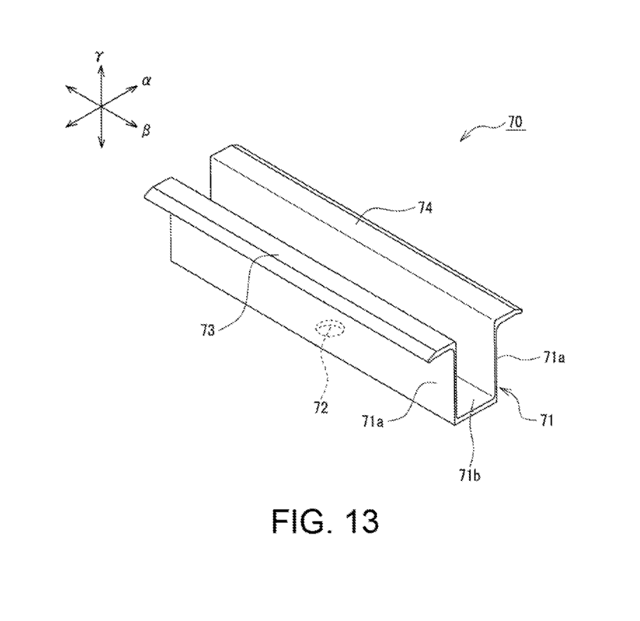

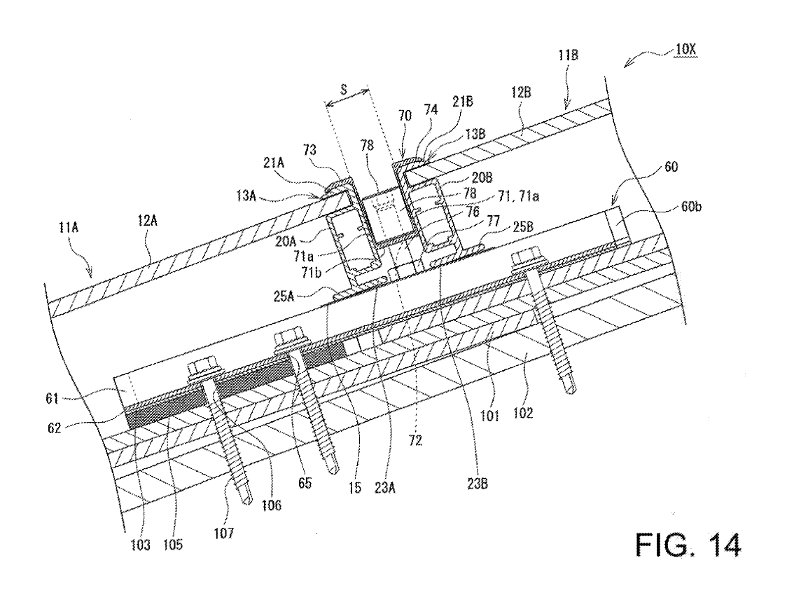

A photovoltaic power generation device 10X (see FIG. 14) is different from the photovoltaic power generation device 10 in using mounting brackets 60 (see FIG. 11, etc.) instead of the mounting brackets 30, and using fixing brackets 70 (see FIG. 13, etc.) instead of the fixing brackets 50. Also, the photovoltaic power generation device 10X includes no base brackets 40 and each fixing bracket 70 is fixed to a mounting bracket 60 by attaching a hex key hole-provided nut 78 (see FIG. 14) to a bolt 76 provided upright on the mounting bracket 60.

FIG. 11 is a plan view of a mounting bracket 60 and FIG. 12 is a sectional view along line CC in FIG. 11. As illustrated in FIGS. 11 and 12, each mounting bracket 60 includes a base portion 61 that allows frames 13A, 13B of solar cell modules 11A, 11B to be mounted thereon and flange portions 62 jutting to the right and the left, respectively, from a lower portion of the base portion 61. Each flange portion 62 is a plate-like fixing portion disposed along a roof surface. In the flange portion 62, a plurality of through holes 65 that each allow a screw 107 for fixing the mounting bracket 60 to a roof 100 to be passed therethrough are formed.

Like the mounting brackets 30, 90, the mounting bracket 60 has a shape that is long in the longitudinal direction along the eave-ridge direction, and a ridge-side edge portion 60b is inclined relative to the eave-ridge direction and the girder direction of the roof 100. The ridge-side edge portion 60b is preferably inclined at an angle θ of approximately 3° to 10° relative to the girder direction of the roof 100. Since a later-described bolt guide rail portion 64 preferably extends straight along the eave-ridge direction, the ridge-side edge portion 60b is preferably inclined by forming a cut surface of the mounting bracket 60 obliquely relative to the longitudinal direction and a lateral direction. In this case, drainage for rain water, etc., can be enhanced without impairing building efficiency.

An eave-side edge portion 60a of the mounting bracket 60 is preferably inclined at an angle that is substantially the same as that of a ridge-side edge portion 60b relative to the eave-ridge direction and the girder direction. The eave-side edge portion 60a is formed at an angle that is the same as that of the ridge-side edge portion 60b in a direction that is the same as that of the ridge-side edge portion 60b. Since the mounting bracket 60 is manufactured, for example, by cutting a long member, cutting the respective end portions at the same angle in the same direction enables elimination of waste of materials. The mounting bracket 60 has a substantial parallelogram shape in plan view, in which the eave-side edge portion 60a and the ridge-side edge portion 60b are substantially parallel to each other and outer ends 62a of the respective flange portions 62 are also substantially parallel to each other.

The base portion 61 includes an upper wall portion 61a that allows the frames 13A, 13B to be mounted thereon, two side wall portions 61b that extend downward from opposite end portions in the lateral direction of the upper wall portion 61a and connect the upper wall portion 61a and the flange portions 62, and a lower wall portion 61c that connects lower ends of the respective side wall portions 61b. The side wall portions 61b are formed, for example, perpendicular to the upper wall portion 61a, the lower wall portion 61c and the flange portions 62. The base portion 61 preferably has a hollow structure from the perspective of, for example, weight reduction and material cost reduction, and includes two hollow portions 67 that are surrounded by the respective wall portions and separated from each other by a bolt guide rail portion 64.

In the base portion 61, the bolt guide rail portion 64 that supports a head portion of a bolt 76 for fixing the fixing bracket 70 in such a manner that the head portion is slidable in the eave-ridge direction is provided so that a shaft portion of the bolt 76 is provided upright so as to face upward. The bolt guide rail portion 64 is provided over an entire longitudinal direction of the base portion 61 in a center portion in the lateral direction of the base portion 61. The bolt guide rail portion 64 is a groove that is formed inside the hollow base portion 61 and opens upward, and parts of the upper wall portion 61a jut above the groove from the right and the left and occlude a part of the opening. The head portion of the bolt 76 is caught on lower surfaces of the upper wall portion 61a that jut from the right and the left, and thus the bolt 76 is held in the bolt guide rail portion 64 in such a manner that the bolt 76 does not come off upward and is slidable along the eave-ridge direction.

The flange portions 62, which jut to the respective outer sides from the lower portion of the base portion 61, are formed over an entire longitudinal length of the mounting bracket 60. In each flange portion 62, through holes 65 that each allow a screw 107 to be passed therethrough are formed so as to be aligned in the eave-ridge direction. The through holes 65 are preferably formed at respective positions no less than 10 mm away from ends of the flange portions 62 in order to prevent entry of rain water, etc., from the parts to which the screws 107 are attached. The through holes 65 are formed, for example, at respective positions no less than 10 mm away from outer ends 62a, which are ends on the outer sides along the longitudinal direction of the flange portion 62, and opposite ends in the longitudinal direction of the flange portions 62 (the eave-side edge portion 60a and the ridge-side edge portion 60b).

FIG. 13 is a perspective view of a fixing bracket 70. As illustrated in FIG. 11, each fixing bracket 70 includes a base portion 71 having a substantially U-shape in side view. The base portion 71 includes two side wall portions 71a formed substantially parallel to each other and a lower wall portion 71b connecting lower ends of the respective side wall portions 71a. In the lower wall portion 71b, a through hole 72 that allows a bolt 76 provided upright on a mounting bracket 60 to be passed therethrough is formed.

Each fixing bracket 70 includes a first holding portion 73 that extends to the eave side from an upper end of the side wall portion 71a disposed on the eave side, and a second holding portion 74 that extends to the ridge-side from an upper end of the side wall portion 71a disposed on the ridge-side. The first holding portion 73 is formed so as to have a length that is shorter than that of a hook portion 21A of the frame 13A and holds the hook portion 21A from above. The second holding portion 74 is formed so as to have a length that is shorter than that of a hook portion 21B of the frame 13B and holds the hook portion 21B from above. Distal end portions of the respective holding portions are slightly flexed downward so as to conform to shapes of respective distal end portions of the hook portions 21A, 21B.

Each fixing bracket 70 may have a length that is substantially the same as a length in a long side direction of each solar cell module 11 and be attached over substantially entire lengths of respective spaces S, but in the present embodiment, has a length that is substantially the same as a width of the mounting brackets 60 in consideration of building efficiency. The fixing brackets 70 are fixed one by one to the respective mounting brackets 60 using bolts 76 and hex key hole-provided nuts 78, with each base portion 71 inserted into a relevant space S. The base portion 71, the first holding portion 73 and the second holding portion 74 are formed over an entire length of each fixing bracket 70. The through hole 72 is formed, for example, at a center portion in the longitudinal direction of the base portion 71.

Each fixing bracket 70 may have a shape in which, regarding heights of the respective holding portions from an upper end of the mounting bracket 60, the first holding portion 73 is relatively higher. The lower wall portion 71b of the base portion 71 may be formed perpendicular to the respective side wall portions 71a, and the lower wall portion 71b may be inclined so that an angle formed by the eave-side side wall portion 71a and the lower wall portion 71b is slightly larger than an angle formed by the ridge-side side wall portion 71a and the lower wall portion 71b.

FIG. 14 is a longitudinal cross-sectional view illustrating a structure for attachment of the photovoltaic power generation device 10X and illustrates a structure in which a ridge-side end portion of the solar cell module 11A and an eave-side end portion of the solar cell module 11B are fixed to the roof 100 using a mounting bracket 60 and a fixing bracket 70.

As illustrated in FIG. 14, the frame 13A installed at the ridge-side end portion of the solar cell module 11A and the frame 13B installed at the eave-side end portion of the solar cell module 11B are mounted on a mounting bracket 60 via an earthing bracket 15. A fixing bracket 70 is inserted into a space S between the frames 13A, 13B from above and a bolt 76 provided upright on the mounting bracket 60 is present below the space S. Then, a hex key hole-provided nut 78 is attached to a shaft portion of the bolt 76 passed through the through hole 72 of the fixing bracket 70, whereby the fixing bracket 70 is fixed to the mounting bracket 60 and presses the frames 13A. 13B from above.

Like the mounting bracket 30, the mounting bracket 60 is fixed to a sheathing roof board 102 of the roof 100 by screws 107 attached to the flange portions 62. The mounting bracket 60 is disposed so that alignment marks 68 and an eave-side edge portion of a roofing material 101 are aligned, and a ridge-side part of the mounting bracket 60 is fixed to the roofing material 101 and an eave-side part of the mounting bracket 60 is fixed to a spacer 105. The frames 13A. 13B are disposed so as to face each other with the bolt 76 therebetween above the upper wall portion 61a of the base portion 61 and with the space S therebetween, the space S enabling the base portion 71 of the fixing bracket 70 to be inserted thereto. A rubber sheet 103 is provided between the mounting bracket 60, and the roofing material 101 and the spacer 105.

In the photovoltaic power generation device 10X, the solar cell modules 11A, 11B are fixed to the mounting bracket 60 in such a manner that solar cell panels 12A, 12B are substantially parallel to the sheathing roof board 102. In this case, a distal end of a bottom plate 23A of the frame 13A floats slightly from the mounting bracket 60 and in heights of hook portions 21A, 21B from the upper end of the mounting bracket 60, the hook portion 21A is slightly higher.

The head portion of the bolt 76 provided upright on the base portion 61 of the mounting bracket 60 is inserted into the bolt guide rail portion 64 (see FIG. 12) and the shaft portion of the bolt 76 faces upward and extends substantially perpendicular to the upper wall portion 61a of the base portion 61. The bolt 76 is slidable in the eave-ridge direction within a range in which the bolt 76 does not come off from the bolt guide rail portion 64, and thus there is a high degree of flexibility in disposition of the frames 13A, 13B, providing excellent building efficiency. The bolt 76 can be fixed so as not to slide, for example, by attaching a nut 77 to the shaft portion.

The fixing bracket 70 is attached straddling the frames 13A, 13B and the shaft portion of the bolt 76 is passed through the through hole 72 formed in the lower wall portion 71b of the base portion 71. Then, the hex key hole-provided nut 78 is threadably connected to a part of the shaft portion of the bolt 76, the part projecting above the lower wall portion 71b. The hex key hole-provided nut 78 presses the lower wall portion 71b from above and thereby fixes the fixing bracket 70 to the mounting bracket 60. The hex key hole-provided nut 78 is, for example, a nut with a hex key hole formed therein, the hex key hole enabling a hex key to be inserted thereto, and is attached with the hex key hole facing upward, using a hex key.

In the fixing bracket 70, the first holding portion 73 presses the hook portion 21A of the frame 13A from above and the second holding portion 74 presses the hook portion 21B of the frame 13B from above. Also, the respective side wall portions 71a of the base portion 71 abut on respective side surfaces along the top-bottom direction of the frame 13A, 13B in the space S, whereby movement of the solar cell modules 11A, 11B in the eave-ridge direction is prevented. An upper end corner portion of the frame 13A is held by the first holding portion 73 and the eave-side side wall portion 71a, and an upper end corner portion of the frame 13B is held by the second holding portion 74 and the ridge-side side wall portion 71a.

According to the photovoltaic power generation device 10X having the above-described structure, it is possible to sufficiently ensure good drainage and protection capability of the roof. As with the photovoltaic power generation device 10, the photovoltaic power generation device 10X is easy to build and has favorable maintainability

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A photovoltaic power generation device comprising:
a first solar cell module including a first solar cell panel and a first frame installed at end portions of the panel;
a second solar cell module including a second solar cell panel and a second frame installed at end portions of the panel, the second solar cell module being disposed next to a ridge-side of the first solar cell module with a space therebetween;
a mounting bracket to be fixed to a roof, the mounting bracket allowing a part of the first frame that installed at a ridge-side end portion of the first solar cell module, and a part of the second frame that is installed at an eave-side end portion of the second solar cell module, to be mounted thereon; and
a fixing bracket for fixing the first and second frames to the mounting bracket,
wherein a ridge-side edge portion of the mounting bracket is inclined relative to an eave-ridge direction and a girder direction of the roof.

2. The photovoltaic power generation device according to claim 1, wherein an eave-side edge portion of the mounting bracket is inclined relative to the eave-ridge direction and the girder direction.

3. The photovoltaic power generation device according to claim 1, wherein the ridge-side end portion of the mounting bracket is inclined at an angle of approximately 3° to approximately 10° relative to the girder direction.

4. The photovoltaic power generation device according to claim 1, wherein:
the mounting bracket includes a plate-like fixing portion to be disposed along a roof surface, the fixing portion including a through hole formed therein, the through hole allowing a screw for fixing the bracket to the roof to be passed therethrough; and
the through hole is formed at a position no less than 10 mm away from an end of the fixing portion.

5. The photovoltaic power generation device according to claim 1, wherein the mounting bracket includes a drainage channel formed over an entire length in a direction along the eave-ridge direction thereof by providing a space between the mounting bracket and the roof.

6. The photovoltaic power generation device according to claim 1, wherein binding band holes that allow binding bands for fixing wires drawn out from the respective solar cell modules to be passed therethrough are formed in the mounting bracket.

7. The photovoltaic power generation device according to claim 1, comprising a base bracket that allows a bolt for fixing the fixing bracket to be fastened thereto, wherein:
the mounting bracket includes a guide rail portion that supports the base bracket in such a manner that the base bracket is slidable in the eave-ridge direction; and
the fixing bracket is fixed to the mounting bracket via the base bracket inserted into the guide rail portion.
